(19) United States
(12) Patent Application Publication
(10) Pub. No.: US 2006/0206352 A1
(43) Pub. Date: Sep. 14, 2006

(54) System for seamless enablement of compound enterprise-processes

(76) Inventor: Arunkumar Ganapathi Pulianda, Flower Mound, TX (US)

Correspondence Address: Michael A. O'Neil;Michael A. O'Neil, P.C., Suite 820, 5949 Sherry Lane, Dallas, TX, 75225, US

(21) Appl. No.: 11/369,084

(22) Filed: Mar. 6, 2006

Related U.S. Application Data
(60) Provisional application No. 60/661,554, filed on Mar. 14, 2005.

(51) Int. Cl. G06Q 99/00

(52) U.S. Cl. 705/1

(57) ABSTRACT

This invention relates to activities pertaining to life-cycle-stages of enterprise-processes, whether implemented within the boundary of a single organization or spanning several organizational boundaries. In particular it relates to (1) establishing a community of participant-systems and a schema to create collaborative capabilities (2) establishing a combination of one or more methods and one or more technologies to impart seamlessness to the end-to-end flow of information and content related to the life-cycle stages of the process, (3) establishing end-to-end visibility to key parameters and (4) establishing ways to control the course and speed of activities associated with one or more life-cycle stages.

### CLAIM OF PRIORITY

Applicant claims priority based on provisional patent application Ser. No. 60/661,554 filed Mar. 14, 2005, the entire content of which is incorporated herein by reference.

### TECHNICAL FIELD

The present invention relates generally to methods and systems to establish a collaborative community of allied participant systems. More particularly it applies to creating an integrated solution framework of machines, workflow methods and logic to enable compound inter and intra enterprise-processes and services in and amongst their autonomous life-cycle stages.

### BACKGROUND OF THE INVENTION

### Prior art

Organizations routinely perform a wide range of activities as part of conducting their business. These activities can be generally grouped into processes. A process is a collection of allied activities (also called tasks, steps, events). A compound process has one or more sub-process, each with its own collection of activities.

An example of an enterprise-process is the set of activities involved in issuing a paycheck to an employee at the end of a pay period. This process could be called ‘payroll processing’. Payroll processing generally involves, for each pay period, (a) collecting the employee's regular work hours and overtime, (b) verifying the accuracy of the data, (c) computing the gross pay, (d) computing various deductions to be applied against gross pay such as retirement plan savings, insurance payments, social security payments, taxes, etc., (e) applying these deductions against gross pay to arrive at net pay, (f) reporting pay details to various local, state, federal authorities as required by law, (g) transferring money to the account against which the employee's pay-check will be issued, (h) updating the accounting system to reflect all data, (i) printing the physical check and finally (j) delivering the check to the employee. Steps (a) through (j) could each be a sub-process.

Organizations are constantly striving to streamline, standardize and automate such intra and inter enterprise-processes, that number in the hundreds. Several enterprise-process-technologies like Enterprise Resource Planning (ERP), Supply Chain Management (SCM) and Customer Relationship Management (CRM) have emerged over the past decade or two to address this need and have found their way into organizations, primarily by offering standardized processes codified in software. For instance, ERP providers like SAP and PeopleSoft offer ‘packaged software’ to implement a standardized ‘payroll processing’ enterprise-process entailed steps (a) through (j) above.

More recently, driven by the phenomenon of services-globalization, organizations are exploring improvement avenues beyond merely streamlining, standardizing or automating. Instead of ‘owning’ or investing in enterprise-process-technologies, some are embracing ‘sourcing’ as a means to obtain needed process capabilities and future improvements from third parties such as IBM, EDS, Hewitt and ACS. Others, especially those that already possess some form of these capabilities, have resorted to ‘outsourcing’ wherein they transfer their assets to third parties and then rent or lease the capability back from the third party. The third party would deploy ERP, SCM and CRM technologies to help it streamline, standardize and automate these processes ‘behind the scenes’ and to secure its own profits and margins.

In this evolving ‘hybrid’ model for the creation and realization of an enterprise-process, its ‘enablement’ generally traverses through several life-cycle stages. For a new process, enablement stages can include conception, construction, resource allocation, deployment, compliance, updates, measurements, benchmarking, fine-tuning, analysis, transactions, service oversight, in-sourcing and eventual de-construction. These stages do not always occur in a particular sequence. Significantly, the ‘enablement’ journey often includes other ‘participants’ besides the enterprise—third party providers of the enterprise-process such as IBM, EDS, Hewitt and ACS, entities specializing in advise and contract facilitation services such as TPI-Monitor, Everest and Equa Terra and entities specializing in services such as analysis, legal advise and benchmarking such as APQC, Hackett, Saratoga and Gartner. These ‘participants’ play critical roles at different stages of the enablement ‘life-cycle’. These participants form the de facto ‘enablement community’ for the process. The character and mix of the ‘participant community’ is changing as the hybrid model evolves.

Also evolving is the suite of methods, techniques and solutions to empower individual ‘enablement’ life-cycle stages of an enterprise-process. At present, each participant in the ‘enablement community’ utilizes its own tools, methods, systems or solutions to fulfill its role in the life-cycle. These are often proprietary, are point-solutions, are fragmented and do not conform to a higher-order, more-encompassing, overarching methodology or structure. Further, there are no standards or mechanisms to sequence and ‘stitch together’ information and content from multiple participant systems and solutions at key vantage-points and to achieve a continuous ‘seamless enablement’ experience, one that masks the irregularities of the underlying autonomous methods, systems and solutions, especially when it involves compound processes.

This lack of inter-operability, standardization and end-to-end visibility and manageability imposes significant overhead and inefficiency on the overall enablement life-cycle: The time, money and energy invested in one life cycle stage of the enablement of an enterprise-process can not be fully or easily utilized or leveraged in subsequent life-cycle stages without considerable rework and normalization.

The current invention overcomes several of the limitations presently preventing the achievement of such a ‘seamless enablement’ of enterprise-processes. It does so by establishing procedures to form communities of allied participant systems, systems that implement enablement-life-cycle workflow algorithms and logic to seamlessly integrate participant systems, workflows and content in a structured framework.

### SUMMARY OF THE INVENTION

Provided is a unique solution to achieve “seamless enablement” of life-cycle-stages of enterprise-processes. The solution is created with three components, (a) community of allied participant systems, (b) systems that implement life-cycle workflow algorithms and (c) logic to seamlessly integrate participant systems, workflows and content in structured framework.

The preferred embodiment of the solution requires the presence and specific combination of each of the three components in a predetermined arrangement and integrated together. The provided combination of methodology and technology:
1. Establishes systems accommodating the steps necessary for the achievement of the preferred outcome for each enablement-life-cycle stage of each addressed process and underlying sub-process, including those that require spanning diverse and heterogeneous computing and communications systems, connection technologies, geographical boundaries, organizational domains as well as multiple organizations.
2. Accommodates a schema entailing unique, distinguishing identifiers for all the necessary physical and logical entities required to establishing an allied ‘systems community’ and to achieving the preferred end-to-end connectedness and flow patterns for information and content.
3. Accommodates the ‘rules’ for creation, exchange, management, organization, archival, retrieval, update, change, version control, distribution, validation and authentication of necessary information elements and multi-media content pertaining to the enablement-life-cycle-stages of enterprise-process, sub-process: both inside the boundaries of a single participant system as well as amongst multiple participant systems.
4. Provides a repository for organization, preservation and modification of ‘enablement’ information and content related to one or many systems, processes, sub-processes, life-cycle stages and participant communities in any number of forms.
5. Codifies the ‘Logic’ for the preferred orchestration of the movement of information and content amongst participant systems so as to achieve an experience of seamlessness. This logic is commercially referred to and realized as SEEPS (Seamless Enablement of Enterprise Processes and Services) standard.
6. Provides one or more user-to-system and system-to-system interfaces and information and content exchange mechanisms.

### BRIEF DESCRIPTION OF DRAWINGS

FIG. 100 is an illustration of an embodiment of the present invention.

FIG. 200 is an illustration of the Enablement Infrastructure components associated with an embodiment of the present invention.

FIG. 300 is an illustration of several embodiments of a User Device connected to an embodiment of a system of the present invention.

FIG. 400 is an illustration of an embodiment of the logical building blocks of a Participant System in an embodiment of the present invention.

FIG. 450 is an illustration of an embodiment of a level of detail associated with in FIG. 400 showing a preferred embodiment of Objects Master Library along with a preferred embodiment of individual constituent libraries.

FIG. 500 is an illustration of an embodiment of a group of Objects and Functions associated with one or more enablement life-cycle stages of an enterprise-process.

FIG. 550 is an illustration of an embodiment of an orchestration of an Enablement-Life-Cycle, assembled via its individual life-cycle-stages comprising a preferred embodiment of enablement for a new enterprise-process.

FIG. 600 is an illustration of an embodiment of a Workflow in an embodiment of a participant system showing an embodiment of workflow involving several workflow objects and functions represented in FIG. 500 and also encompassing several enablement life-cycle stages for an enterprise process.

FIG. 700 is an illustration of an embodiment of logic utilized within an individual Object as represented in FIG. 500.

FIG. 800 is an illustration of an embodiment of a State-Management-Logic pertaining to carrying out the sequence of activities associated with eliciting updates to information and content associated with an enterprise-process.

FIG. 900 is an illustration of an embodiment of the Identity Schema in an embodiment of a participant system.

FIG. 1000 is an illustration of an embodiment of the Seamless Enablement Schema in an embodiment of a participant system, identifying some of the logic elements and associated with FIG. 400.

FIG. 1050 is an illustration depicting the Data Interchange Logic utilized to move information and content between participant systems during enablement.

FIG. 1100 is an illustration of a Screen Layout presented to a user of an embodiment of a participant system for purposes of operating the embodiment of the system.

### DETAILED DESCRIPTION

The detailed description herein along with references to drawings describes the best mode of practicing the invention known at this time. While it is described in connection with presently preferred embodiments, it will be understood that it is not intended to limit the invention to those embodiments. On the contrary, it is intended to cover all alternatives, modifications, and equivalents included within the spirit of the invention.

For ease of illustration, assume that the invention is utilized for the purpose of enabling the ‘payroll processing’ enterprise-process, one pertaining to the set of activities involved in issuing a paycheck to an employee at the end of a pay period and described more fully earlier in the ‘background’ section hereof. As was indicated, this enterprise-process in its current form consists of 10 steps/sub-processes, each with one or more activities.

Also, assume that the enterprise wherein the ‘payroll-processing’ process is being considered desires to derive certain business and/or operational outcomes. Depending on the particular situation at hand, the expectations for outcomes could include some or all of: (a) achieve the most efficient payroll-processing process across all life-cycle stages (b) reduce overall-process costs (c) optimize the level of service available to beneficiaries of the process (d) achieve greater visibility into process details (e) re-align process components (f) profile the risks and benefits of outsourcing some or all of the process steps (g) profile the risks and benefits of retaining some or all of the process steps in-house (h) transfer responsibility for one or more aspects of the process to an expert third party, i.e., outsource (i) establish fully burdened cost and resource profiles for one or more aspects of the process (j) maintain currency of key process data (k) establish metrics for the process with a view to continually track and optimize the process in and across its life-cycle stages (l) revert responsibility for one or more process aspects from an outsourcer back to the enterprise (m) compare the competitiveness of the in-house process with industry peers and alternative providers and also to (n) ensure compliance with various internal and regulatory requirements.

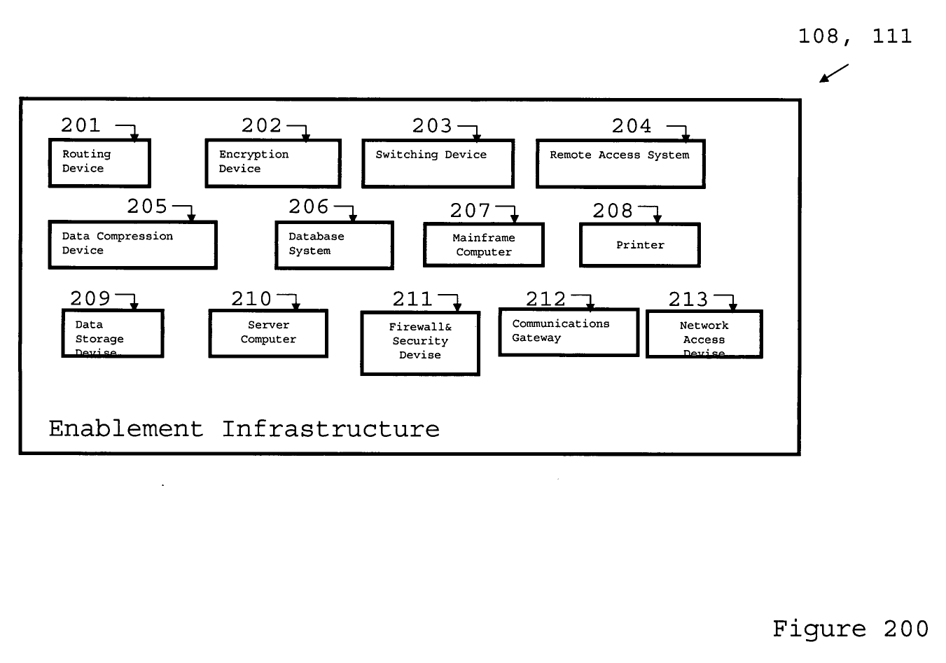

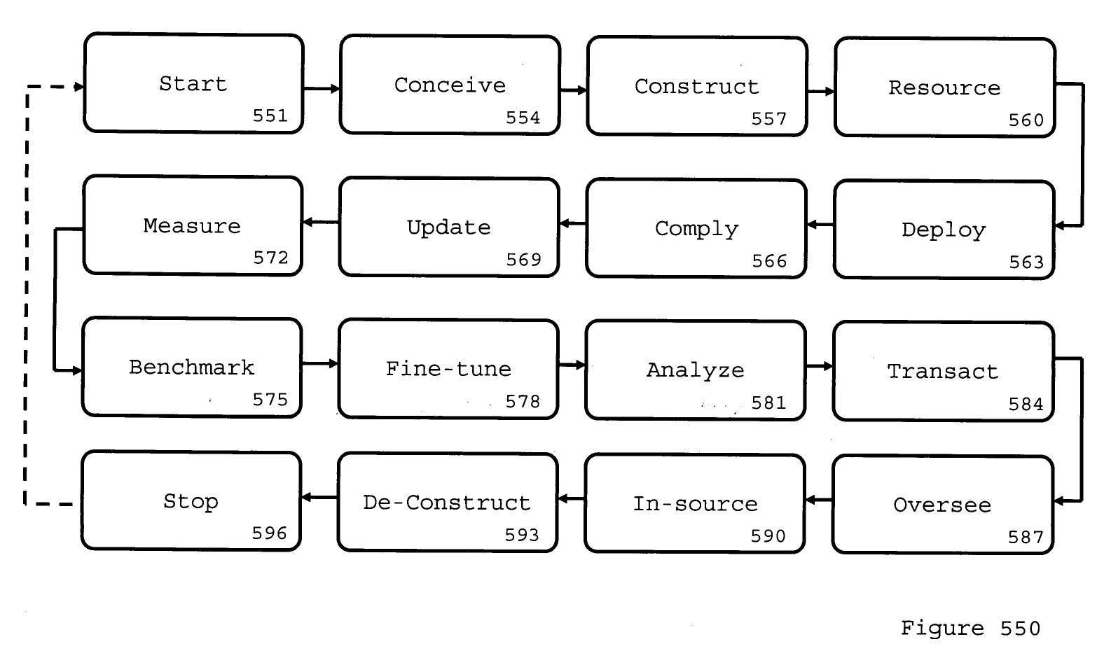

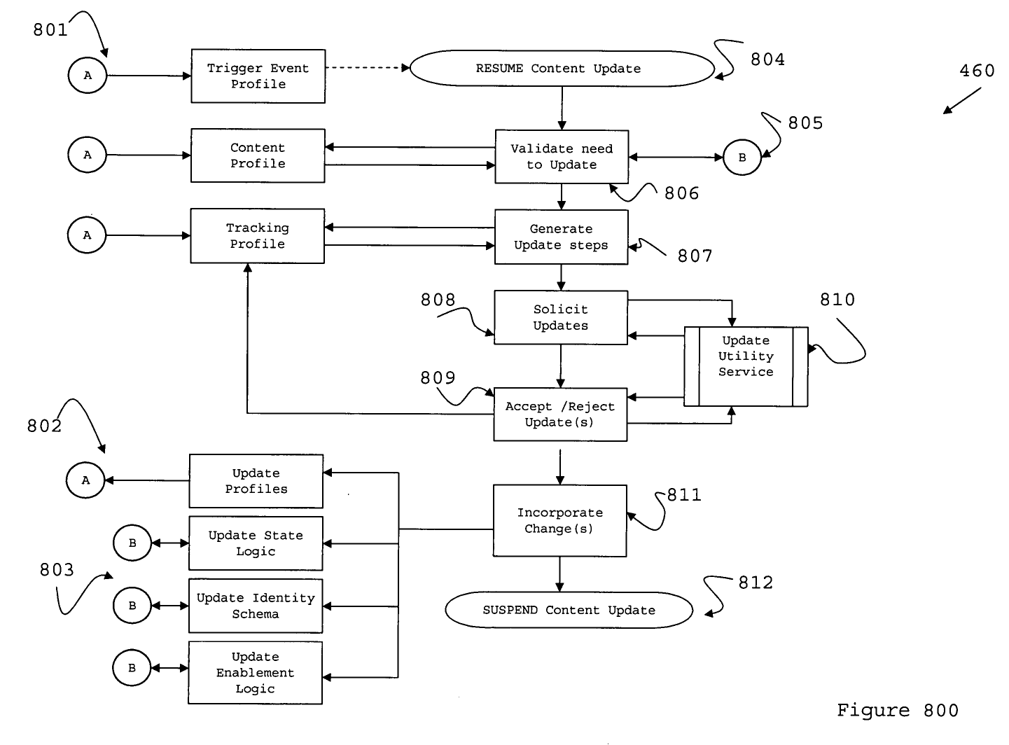

Further, for illustration, assume that a preferred embodiment of the end-to-end enablement-life-cycle for the ‘payroll processing’ enterprise process is implemented and achieved via Sixteen (16) individual, related, connected life-cycle stages as shown in FIG. 550, namely:
1. Start stage (item 551) involving the activities associated with initiation of enablement of the payroll-processing enterprise-process
2. Conceive stage (item 554) involving the activities related to articulating requirements related to business, functions, outcomes and deliverables in the form of a simple/compound process for payroll-processing
3. Construct stage (item 557) involving the activities related to establishing the details associated with the conceived process and its underlying sub-processes, including, but not limited to technologies, locations, organizational participants, external participants, services, deliverables expected at each step, performance indicators and metrics associated with each step, roles and responsibilities of individuals at various stages in the process, etc.
4. Resource stage (item 560) involving the activities to associate physical, financial, environmental, structural, human, technological and other resources to realize the process and bring it to life within the Enterprise
5. Deploy stage (item 563) involving the activities related to deployment of payroll-processing enterprise-process to appropriate beneficiaries and stakeholders, including the providing of related technologies such as an ERP system, user education and demand management via internet portals, development and release of service catalogue depicting various payroll-processing services available for use and charges if any, and other appropriate means to allow users of this process/service to request, avail, utilize and comment.
6. Comply stage (item 566) involving the activities related to identifying, documenting, customizing, formalizing and codifying the procedures associated with complying with all the necessary requirements imposed by the Enterprise as well as by other parties such as the Government and other regulatory entities at one or more process-step and/or life-cycle stage.
7. Update stage (item 569) involving the activities related to documenting and updating policies, procedures, steps and the logic to ensure currency of required data, information and content associated with the process at pre-determined times and upon occurrence of certain events within the life-cycle of the payroll-processing-process. A specific example of such an occurrence is illustrated by an embodiment of a procedure to update the key process-profile elements at certain points and times during its life-cycle. This procedure ensures that key metrics and performance data associated with the payroll-processing process is updated regularly by certain users of the system(s) having the responsibility to do so. These users are made known to the system(s) along with the technical means to solicit and elicit updates from them. FIG. 800 describes the flow of an embodiment of this procedure, called ‘Asynchronous Content Tracking, Indexing and Verification Engine’ (ACTIVE). The procedure assumes the ready availability of the requisite embodiment of enablement infrastructure as in FIG. 200 for this purpose.
8. Measure stage (item 572) involving the activities associated with gathering, interpreting and gaining insights from the various metrics and measures of the process.
9. Benchmark stage (item 575) involving the activities associated with ascertaining the relative competitiveness of one or more aspects of the process, in relation to other organizations wherein a similar process is deployed and/or in relation to the capabilities of third party professional organizations capable of providing such a process as an outsourced service to the Enterprise.
10. Fine-tune stage (item 578) involving the activities associated with optimizing one or more aspects of the process: technology, staffing, process structure, cost, service level, etc.
11. Analyze stage (item 581) involving the activities for undertaking a focused analysis of the process to determine various options to achieve desired business improvements and/or improve specific process metrics such as cost ratio, service level, skill level, systems integration, etc.
12. Transact stage (item 584) involving the activities associated with events, people, techniques, and content pertaining to modifying the responsibility for provisioning of the payroll-processing-process from its current arrangement to a newer one wherein other, external providers of this process or other parts of the Enterprise, or both, may be involved in some manner. These activities can include creation and release of documents such as a Request For Information (RFI) and Request For Proposal (RFP), Analysis of bids from various parties, Selection of one or more entities to take on the responsibility for one or more aspects of the process, Construction of various contractual documents and finally the actual transferring of work, staff and responsibilities to the new arrangement.
13. Oversee stage (item 587) involves the activities relating to the steps, procedures and norms associated with oversight of timeliness, accuracy, credibility etc. of various aspects of the payroll-processing process during its enablement-life-cycle, including when these are performed by an outsourced provider.
14. In-source stage (item 590) involves the activities relating to the procedures, the investigations and also several steps in the Transact-Stage (item 584) to achieve the migration and assumption of aspects of the process from external parties or outsourcers to the jurisdiction of the Enterprise.
15. De-construct stage (item 593) involves the activities relating to dismantling the payroll-processing process either because it is no longer needed or is no longer needed in its current form.
16. Stop stage (item 596) involves the activities pertaining to cessation of current sequence of enablement-life-cycle-activities and/or to prepare for the next round of enablement.

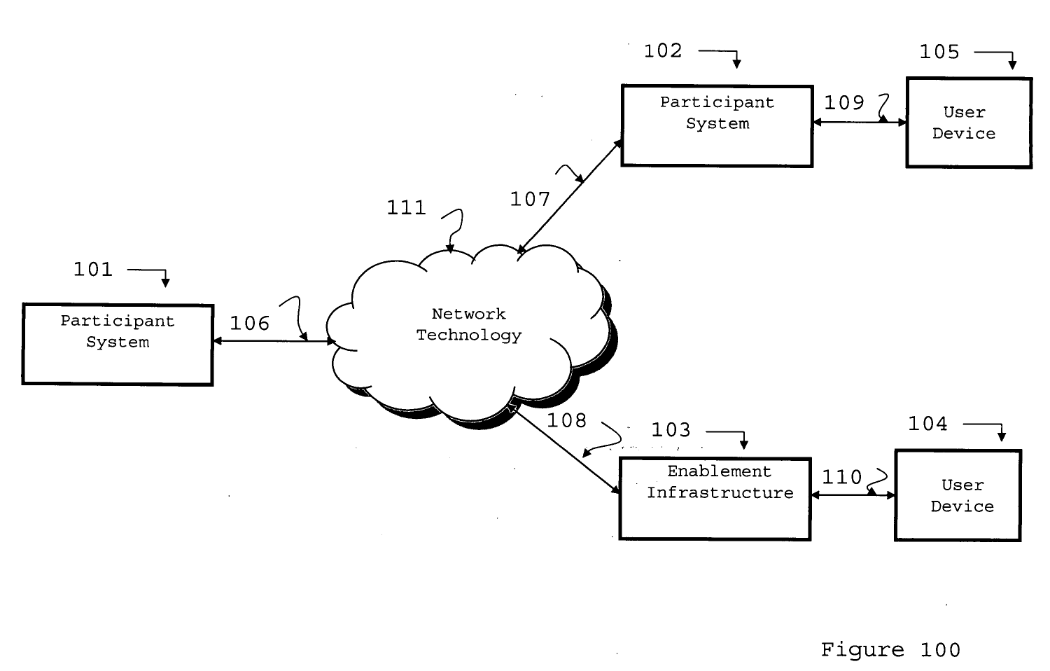

FIG. 100 shows a simplified version of a preferred embodiment of a participant community associated with the enablement of the payroll-processing process through its life-cycle stages.

The embodiment in FIG. 100 consists of two participating authorized systems item 101 and item 102 connected via a network item 111 and additional enablement infrastructure item 103. Users access these systems either directly as in item 105 or via an intermediary enablement infrastructure as in item 104. Various additional forms of connections item 106, item 107, item 108, item 109 and item 110 provide the pathways for movement of information and content amongst and beyond the participant community. As known to those familiar in the art, the particular embodiment is illustrative and is not meant to limit the number of authorized participant systems or exclude other embodiments of physical placement, connection and access.

FIG. 200 is an illustration of an embodiment of the infrastructure utilized in an embodiment of the solution for the Enterprise. The current illustration accommodates various telecommunications, computing, access, security and other devices typically utilized to establish connected communities for the purpose of this invention or similar purposes. The current embodiment includes one or many: routing devise item 201, encryption device item 202, switching device item 203, remote access system item 204, data compression device item 205, database system item 206, mainframe computer item 207, printer item 208, data storage device item 209, server computer item 210, firewall device item 211, communications gateway item 212 and network access device item 213. These components make it possible for the Enterprise to connect its pertinent ‘enablement’ systems with other pertinent ‘enablement’ systems. As is familiar to individuals knowledgeable in the art, these technologies are ubiquitous and are not a part of this invention except to the extent one or more of the components in FIG. 200 are specifically altered with specific hardware or software related to this invention to impart a role generally not offered as a standard feature by its original creator, in which event this invention incorporates only those specific alterations.

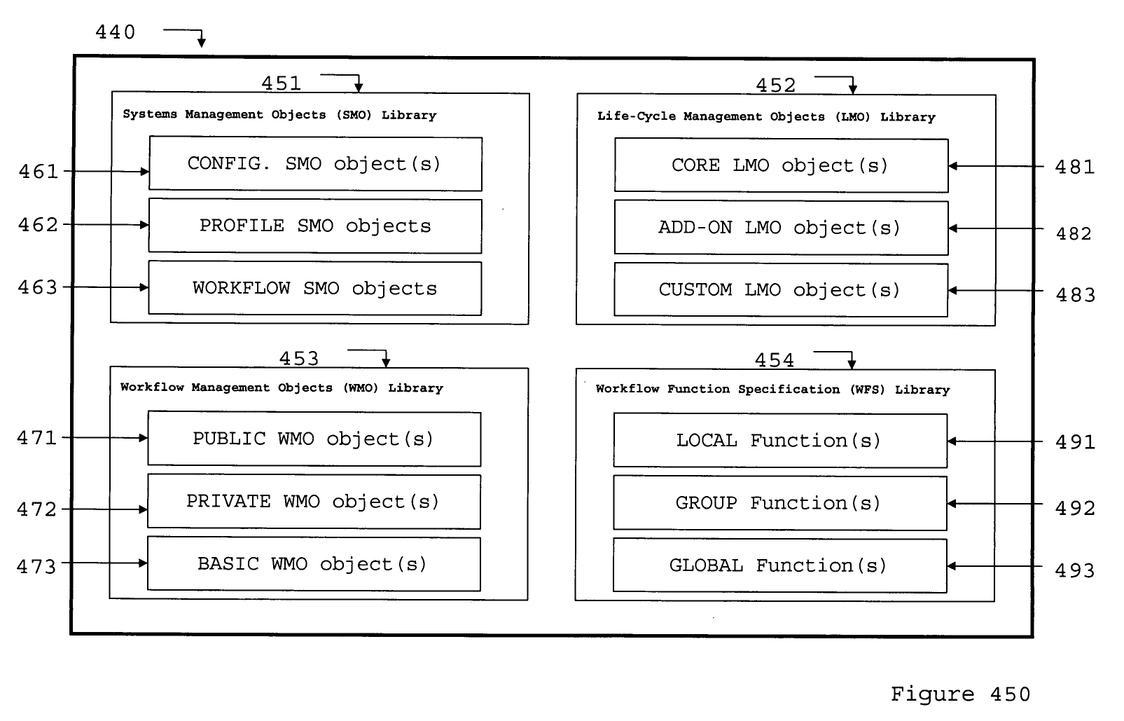

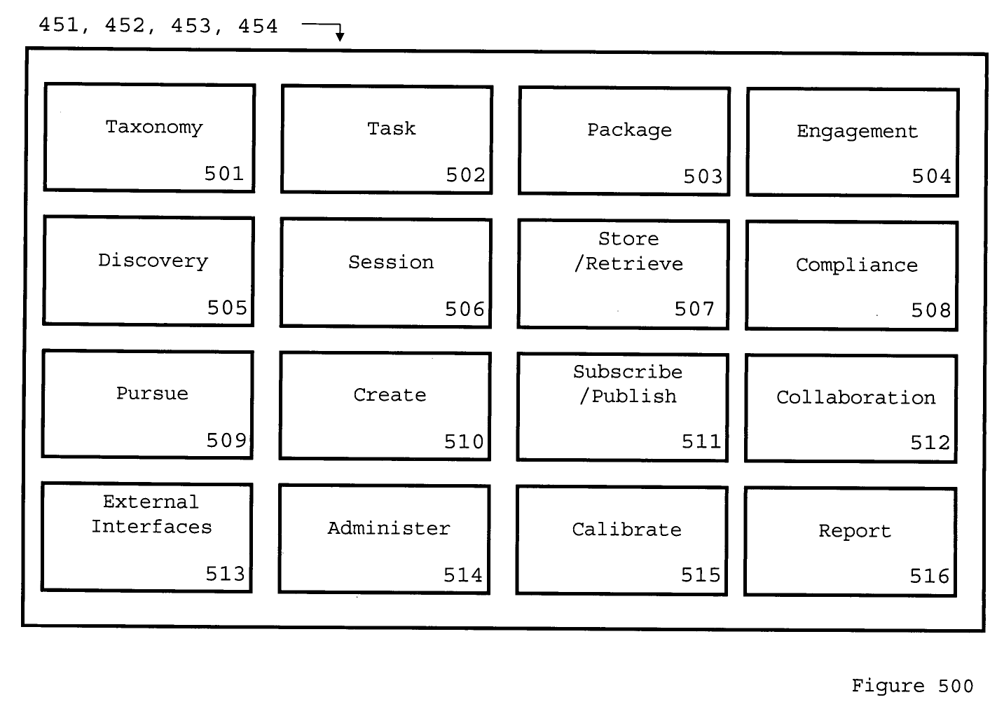

System-to-system interface for movement of information and content for purposes of end-to-end enablement, as between systems item 101 and item 102 in FIG. 100 is achieved via a preferred embodiment illustrated in FIG. 450 and FIG. 500.

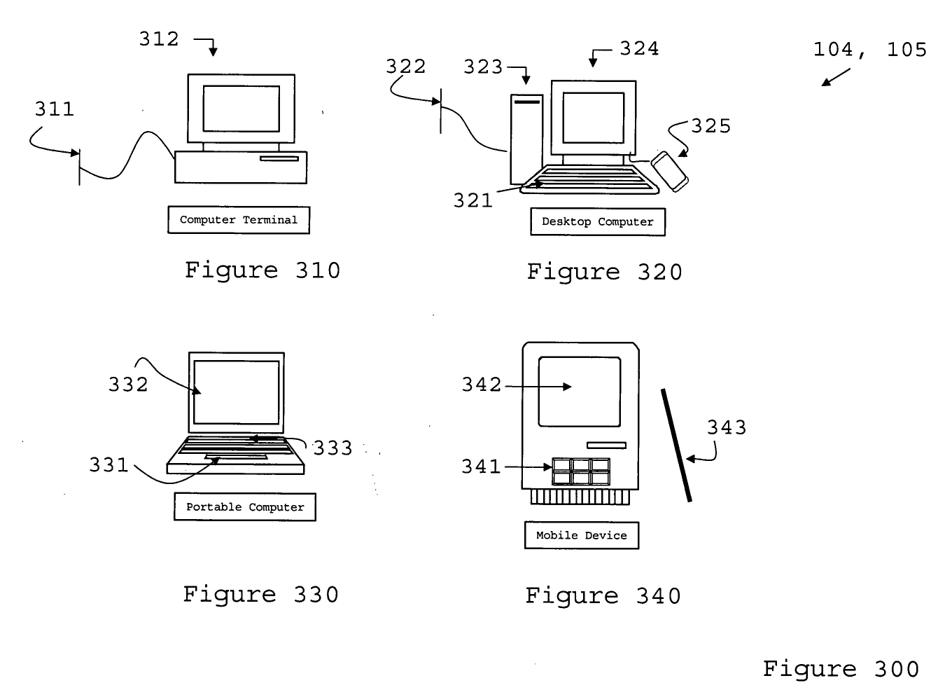

Regarding provisioning of human-to-system interface, FIG. 300 is an illustration of several embodiments of devises and mechanism. In the event the entire enablement system is implemented in a single monolithic system such as an IBM 3090 machine, all users would utilize a terminal device similar to FIG. 310 consisting of a display screen item 312 and connected to the enablement infrastructure item 311. If the enablement system is organized as a collection of smaller underlying systems, each implemented on a server such as provided by SUN Microsystems or Hewlett Packard, these would likely be accessed via a desktop computer device similar to FIG. 320 involving a keyboard item 321, infrastructure connection item 322, a CPU unit item 323, a display screen item 324 and a computer mouse item 325, as well as via devices in FIG. 330 involving a keyboard item 333, a display screen item 332 and a mouse-equivalent touchpad item 331 and device in FIG. 340 involving a keypad item 341, a touch-sensitive screen item 342 and a mouse-equivalent wand item 343.

In a preferred embodiment of the invention, the totality of the involved entities consists of one or more of (i) the Enterprise associated with the payroll-processing process, (ii) a potential future provider of some or all of the payroll-processing process to the Enterprise (iii) a provider of advisory services such as assessments, sourcing transaction facilitation and contract governance related to the enablement of the payroll-processing process across one or more of its life-cycle-stages (iv) a provider of specialized services such as benchmarking and research related to the payroll-processing process, (v) computing systems executing the ‘enablement’ workflow software derived from this invention at each entity, (vi) computing systems executing software related to the payroll-processing process such as ERP, (vii) enablement infrastructure as in FIG. 200 to interconnect items (i) through (vi) in this paragraph in the intended manner, (viii) Screen displays of enablement related information and content on computers, mobile devices or other authorized devices as in FIG. 300 and (ix) users interacting with devices in (viii) as in FIG. 100 in for the purpose of interacting with the systems (v) and (vi).

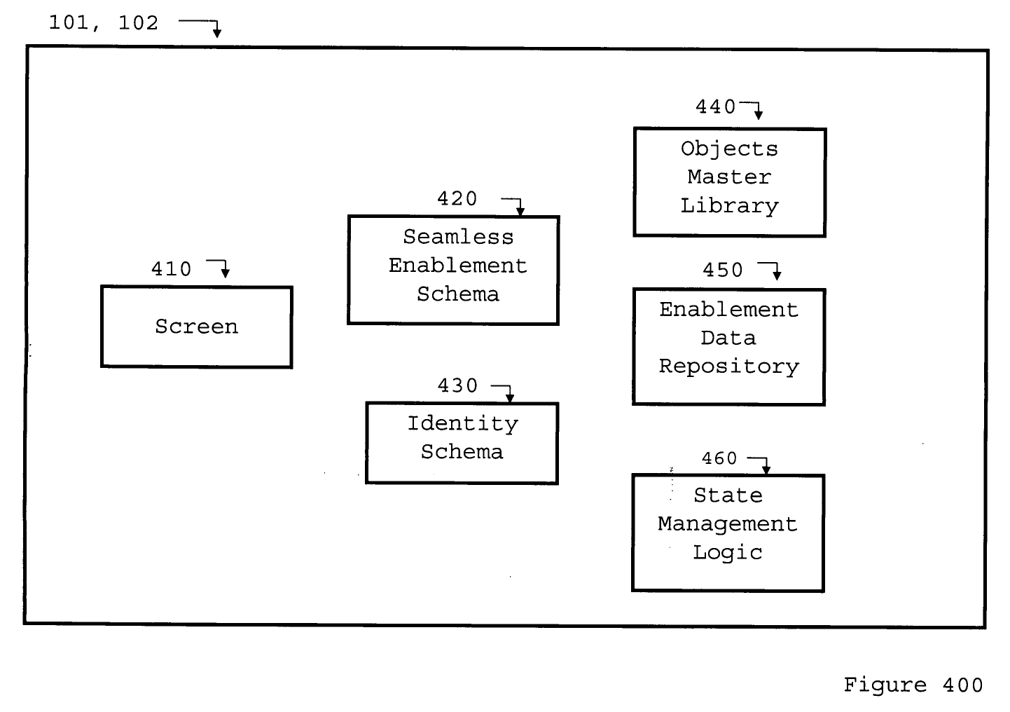

FIG. 400 depicts the logical blueprint for a preferred embodiment of a participant system in the invention. These building blocks are primary guides to construction of the system similar to an architectural blueprint for a building being a primary guide to engineers constructing the building. Regarding FIG. 400:
A primary element in the system is the Enablement Data Repository item 445. This is the storehouse for all the data and content related to all the enablement life-cycle-stages of all the processes supported by this system. Additionally, it also stores data and content about all other systems it is in contact with or has been in contact with for enablement purposes. The actual construction of the data repository is implemented through the use of commercial products from companies such as Microsoft, Oracle, IBM as well as via software currently known as ‘open source software’ to those knowledgeable in the art.

Another primary element in the system is the Objects Master Library item 440. This is where much of the business-logic for the workflow associated with various enablement life-cycle stages is organized. In fact, this is a ‘library of libraries’. FIG. 450 reveals additional detail for a preferred embodiment of item 440:
The Systems Management Objects (SMO) Library item 451 illustrates an embodiment of a preferred category of software modules, called objects, responsible for the overall working of the system. Configuration objects item 461 ensure basic integrity of the system. Profile objects item 462 ensure that appropriate information and content about users, systems, communities, security, permissions etc. are maintained. Workflow objects item 463 ensure that all the accommodated processes and all activities related to all the applicable life-cycle-stages are initiated, carried through and completed as required.

The Life-Cycle Management Objects (LMO) Library item 452 illustrates an embodiment of a preferred category of objects responsible for each life-cycle stage during enablement, as was illustrated earlier with references to items in FIG. 550. The Core objects item 481 carry out workflows related to a preferred embodiment of a suite of life-cycle stages of the payroll-processing process. The Add-on objects item 482 provide community participants the mechanism to extend or create variations to the enablement process and/or life-cycle to meet specific enablement needs. The Custom objects item 483 takes the flexibility offered by the Add-on objects item 482 to a new level by allowing for the use of highly proprietary objects.

The Workflow Management Objects (WMO) library item 453 illustrates a preferred embodiment of objects that are responsible for scripting the actual sequence of activities within each of the workflow stages of each enterprise-process accommodated in the system. Basic objects item 473 provide an off-the-shelf set of capabilities. Private objects item 472 makes it possible to incorporate participant-specific approaches. Public objects item 471 makes it possible to use de-facto and de-jure approaches.

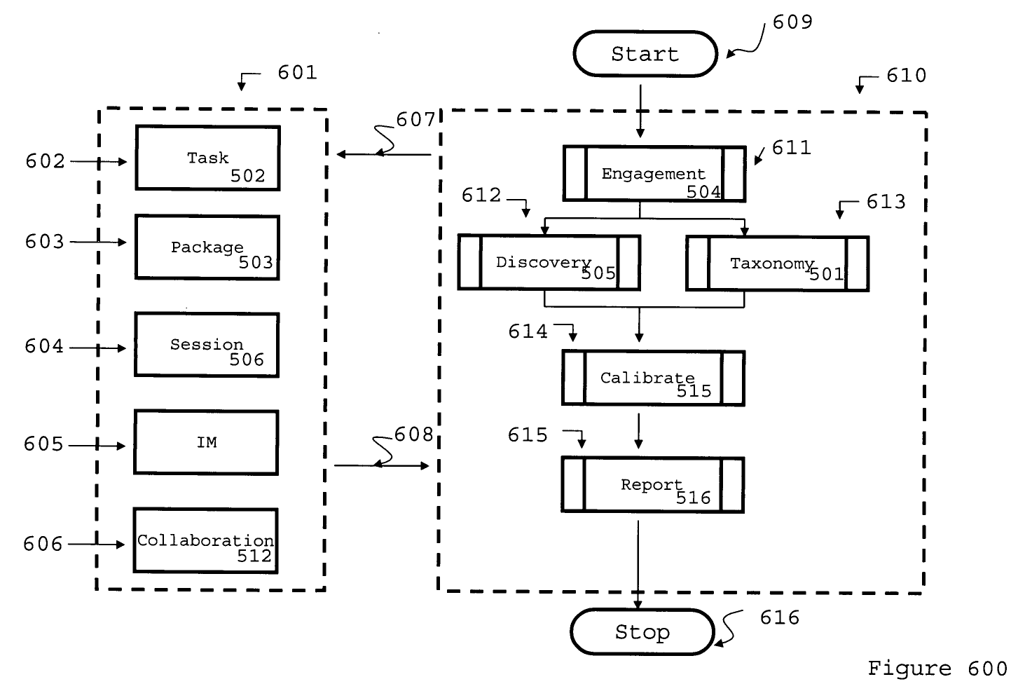

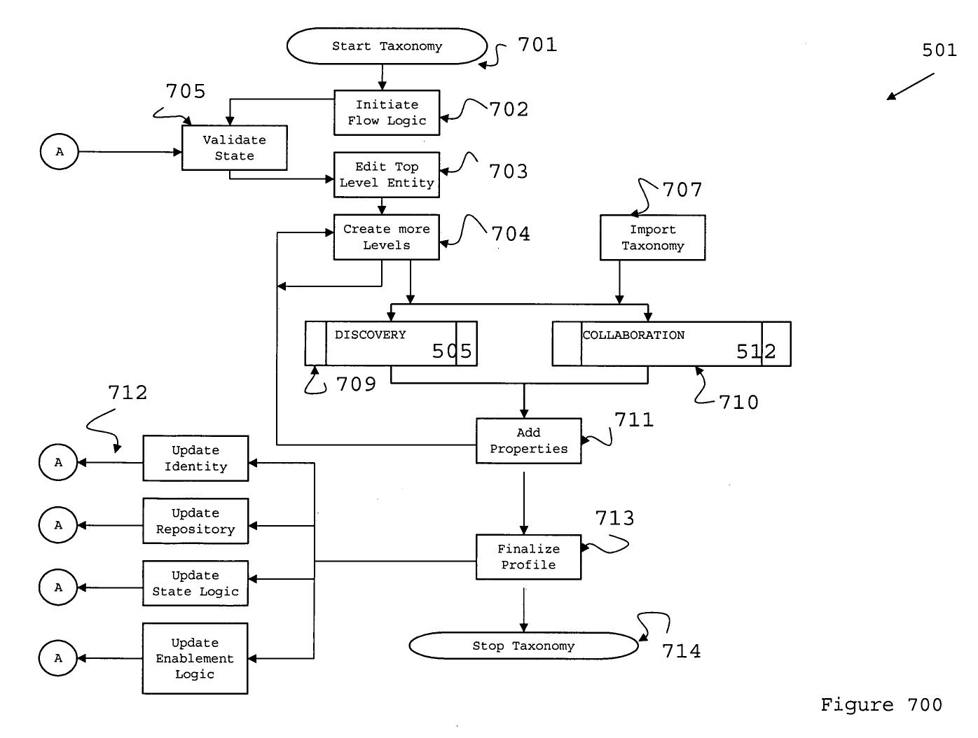

FIG. 600 shows an illustration of an example of a workflow script associated with a preferred embodiment of enterprise-process enablement, entailing several life-cycle-stages, involving some of the Core Objects item 481 and starting with action item 609 and ending with action 616. Objects performing the actions for various enablement life-cycle stages are organized as a group in action group 610 and objects performing actions in a supporting role are organized as another group in action group 601. Actions 607 and 608 allow for the flow of data, logic, commands, status as is customary as known to those knowledgeable in the art. Upon initiation via action 609, the script invokes via the next action 611, the Engagement object item 504 which ensures, through one or more preferred embodiments of the screen item 410 in FIG. 400, that all the information required for the initiation or continuation or modification of an engagement is collected and processed. In the process, it initiates two actions, 612 and 613 and invokes two objects, Discovery object item 505 and Taxonomy object item 501 to assist it. The Discovery object item 505 solicits and elicits information from various users and systems pertaining to the payroll-processing process through several preferred embodiments including web-based data collection methods. The Taxonomy object item 501 engages users and machines to solicit and elicit information and content to generate a detailed ‘family tree’ for the payroll-processing process, as illustrated in FIG. 700:
Action 701 starts the process of building the ‘family tree’ for the payroll-processing process. Action 702 follows and initiates the flow logic for the object and entails a validation of the current state of the ‘family tree’ if any, via action 705. The response then guides action 703, involving the creation of the ‘apex’ of the family tree. Action 704 follows wherein additional branches of the family-tree are defined and documented. If required, the use of two other objects, Discovery item 505 and Collaboration item 512 are allowed via actions 709 and 710 respectively. In the event the use of a specialized taxonomy structure such as one proposed by the American Productivity Quality Center (APQC) is warranted, it can be received through action 707. As the family-tree emerges, each node in the tree is associated with properties via action 711. When the entire family-tree for the payroll-processing-process is complete, the process is finalized via action 713 and all the appropriate data tables and repositories are updated via action 712. Action 714 stops the Taxonomy process.

As the enablement life-cycle proceeds, when the Enterprise requires a benchmark exercise to be undertaken, the script activates action 614 and invokes the Calibrate object item 515 to carry out its role. This object coordinates the organization of data for benchmarking purposes, delivery to participating systems that specialize in benchmarking, receipt of benchmark reports and updates to the Enablement Data Repository item 445 in FIG. 400. The script then invokes via action 615 the Report object item 516 to create various reports regarding the enablement of the payroll-processing process.

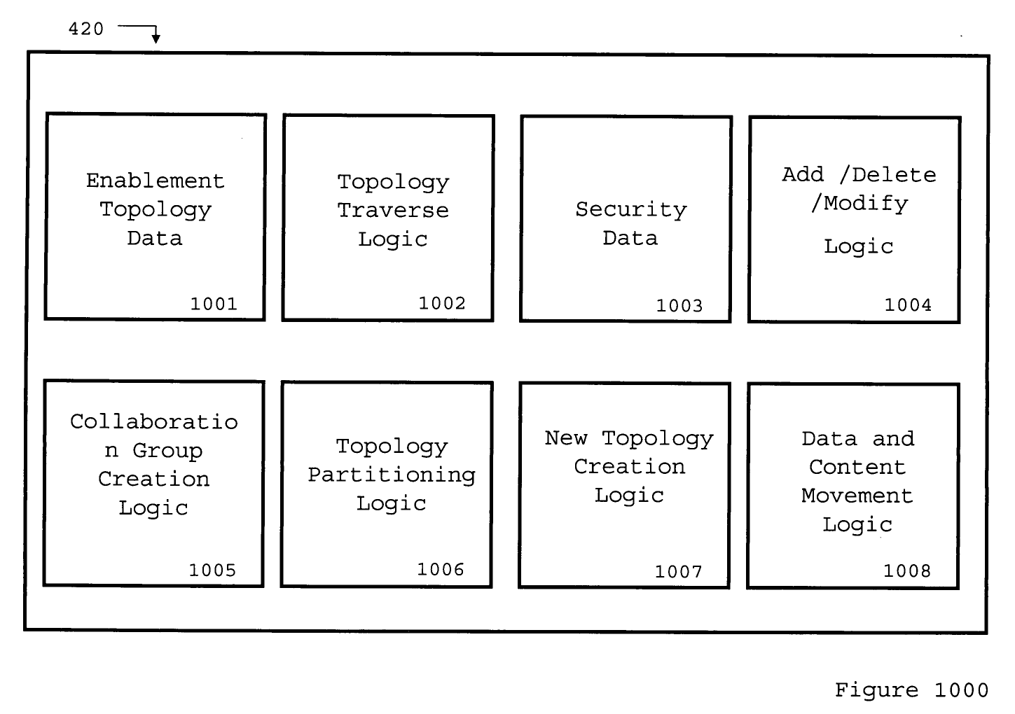

Along the way, the script is able to utilize the services of the Task object item 502 via action 602 to document and track various tasks, and the Package object item 503 via action 603 to assemble, package, ship and receive bundles of data and multimedia content between participant systems utilizing structures in item 1051 and item 1052, logic and Rules engine item 1060—associated with the Data and Content Movement Logic item 1008 in FIG. 1000. Further, the script is able to utilize the services of the Session object item 506 via action 604 to set up and carry-out and record a variety of audio, video and web-based conference sessions and capture the contents of such session in multi-media format in repository item 445 in FIG. 400 as is understood by those knowledgeable in the art. Also, the script is able to utilize via action 605 the Instant Messaging (IM) object to establish and carry out device-to-device exchange of information between users of participant systems. Additionally, the script is able to utilize, via action 606, the Collaboration object 512 that allows several devices to work together from geographically remote locations to author, modify and reconstruct documents, graphical presentations and spread-sheets to transform it from an earlier version to its next version.

The Workflow Function Specification (WFS) Library item 454 illustrates a preferred embodiment of functions for all the objects associated with FIG. 400. Functions are components of objects. Local functions item 491 fulfill tasks associated with a system. Group functions item 492 fulfill tasks associated with an allied set of systems or an embodiment of a collaborative suite of participant systems. Global functions item 493 fulfill tasks spanning multiple participant systems.

FIG. 500 illustrates a preferred embodiment of a selective suite of a combination of objects and functions associated with item 451, item 452, item 453 and item 454 in FIG. 400. As an example, the Taxonomy object item 501 is utilized to develop a detailed hierarchical ‘family tree’ structure for an enterprise-process domain, starting with the topmost level of the enterprise and drilling down until all the processes in the domain have been accounted for. The Store/Retrieve object item 507 is utilized to store content in defined structures and to retrieve them based on ‘context’ such as keywords. The Compliance object item 508 is utilized to solicit, elicit, organize, monitor and report on various compliance-related issues pertaining to various enablement life-cycle stages of the payroll-processing process. The Pursue object item 509 is utilized within participant systems deployed by the providers of outsourced services to participate in responding to bid solicitations and to collaborate with Enterprises to win their business or variations of such an embodiment. The Create object item 510 is utilized within participant systems deployed by entities providing specialized enablement services such as research, news, publications as well as similar variations of such an embodiment. The Subscribe/Publish object item 511 is utilized for the purpose of organizing the methods and procedures involved in subscribing to data and content from authorized sources and to delivering these to authorized sources. The External Interfaces object item 513 is utilized to move data and content amongst systems that are selectively involved in the enablement life-cycle and includes such as General Ledger systems, ERP systems and Business-Intelligence systems as is familiar to those knowledgeable in the art. The Administer object item 514 is utilized to provide house-keeping services to all the participant systems in the community. The Calibrate object item 515 coordinates the organization of data for benchmarking purposes, delivery to participating systems that specialize in benchmarking, receipt of benchmark reports and updates to the Enablement Data Repository item 445 in FIG. 400.

Another primary element in the system is the State Management Logic item 460. This element embodies the processes for creation, exchange, management, organization, archival, retrieval, update, change, version control, distribution, validation and authentication of necessary information elements and multi-media content pertaining to the enablement-life-cycle-stages of enterprise-process, sub-process: both inside the boundaries of a single participant system as well as amongst multiple participant systems. An example of an embodiment of such a process is a process named ACTIVE (Asynchronous Content Tracking, Indexing and Verification Engine) within the suite of processes in item 460, one associated with regular updates to the various metrics, profile elements and key indicators associated with the payroll-processing process during its life-cycle either solicitations from responsible individuals or systems. As the enterprise undergoes changes during the course of its business, so does the payroll-processing process. These changes involve, for instance, the number of individuals serviced, the number of individuals responsible for providing the payroll-processing service(s), the locations where the resources within the enterprise are situated, the specifics of third parties that may be involved in the end-to-end process, the organizational structure and number of metrics measured. These actions are depicted in FIG. 800.

Action 804 resumes the update process upon being triggered by an event 801. The process verifies the need for such an update via action 805 and 806 and generates the requisite steps via action 807. The procedure then invokes actions 808 and 810 to solicit updates. Any or a combination of a number of embodiments of preferred techniques is utilized to achieve such an update including the use of ‘push’ technologies, Electronic Data Interchange (EDI) and use of e-mails with associated hypertext links that guides the individual responsible for the update through the specific steps to complete in order to achieve the point-in-time update to required parameters. The procedure invokes action 809 to validate and apply the changes and then invokes action 811 to incorporate all the changes and updates in various data repositories and tables as depicted in actions 802 and 803. Action 812 then suspends the procedure until it is invoked again.

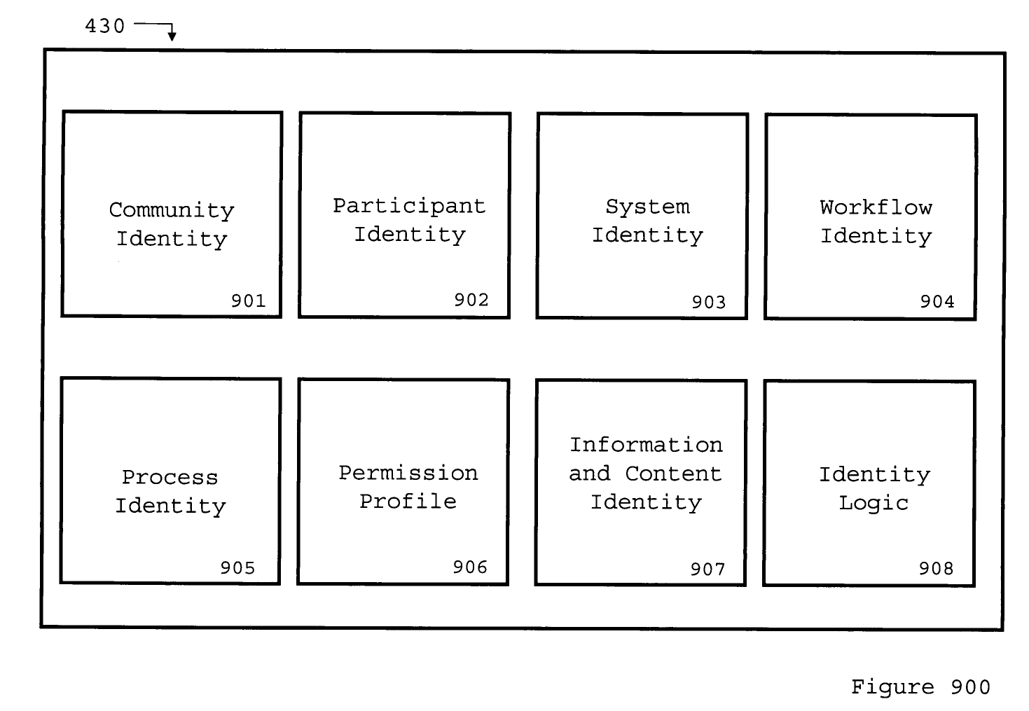

Another primary element in the system is the Identity Schema item 430. This element embodies the needed intelligence and structure to obtain, organize and maintain identities of all needed entities in the participant community, from the largest component to the smallest component. FIG. 900 depicts an embodiment of the entities tracked within this schema. In an embodiment of the schema, it maintains the identity of the Community as in item 901, the identity of all participants as in item 902, the identity of all the systems as in item 903, the identity of every workflow in the end-to-end life-cycle as in item 904, the identity of each process and sub-process as in item 905, the profiles of permissions for all actions for all entities as in item 906, the identity of all information elements and content as in item 907 as well the logic and procedures involved in accomplishing all of these in item 908.

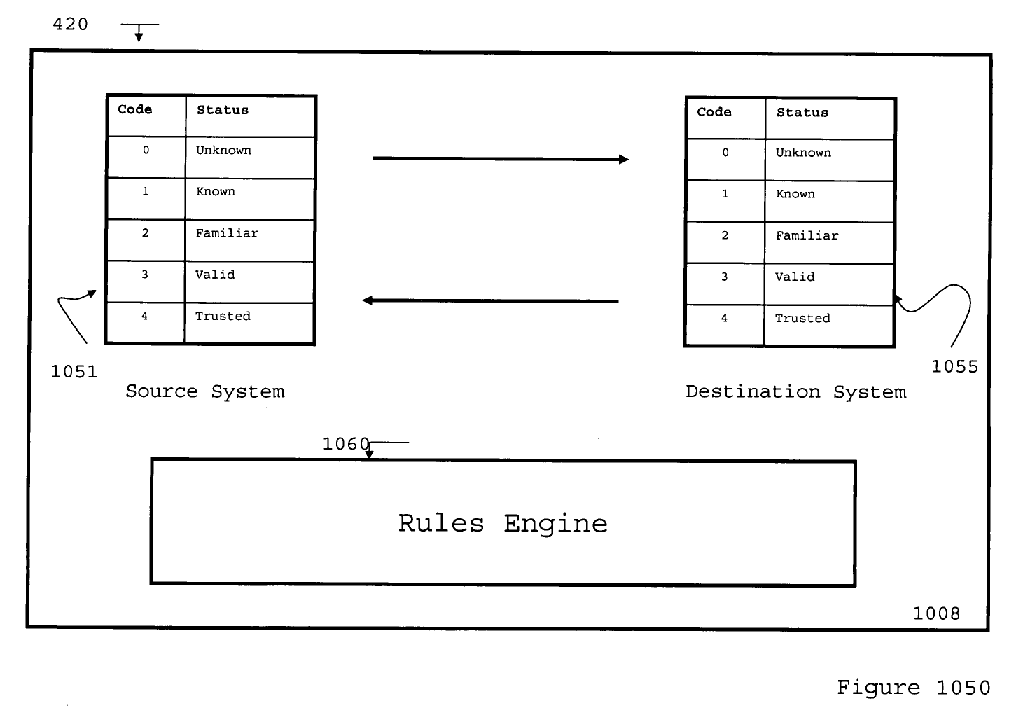

Another primary element in the system is the Seamless Enablement Schema item 420. This element embodies the needed intelligence and structure to obtain, organize and maintain all the details pertaining to the physical and logical topology and information/content-flow pathways in the every participant community. FIG. 1000 depicts an embodiment of the entities tracked within this schema. In an embodiment of the schema, it maintains all the enablement topology data as in item 1001, the logic and rules on how to traverse the topology as in item 1002, security, confidentiality and privacy data as in item 1003, the logic to add, delete and modify enablement data as in item 1004, the capability to create collaboration-groups as in item 1005, the ability to create sub-groups as in item 1006, the ability to establish brand-new topologies as in item 1007 and the logic and rules to move data and content as in item 1008 and as additionally elaborated in FIG. 1050.

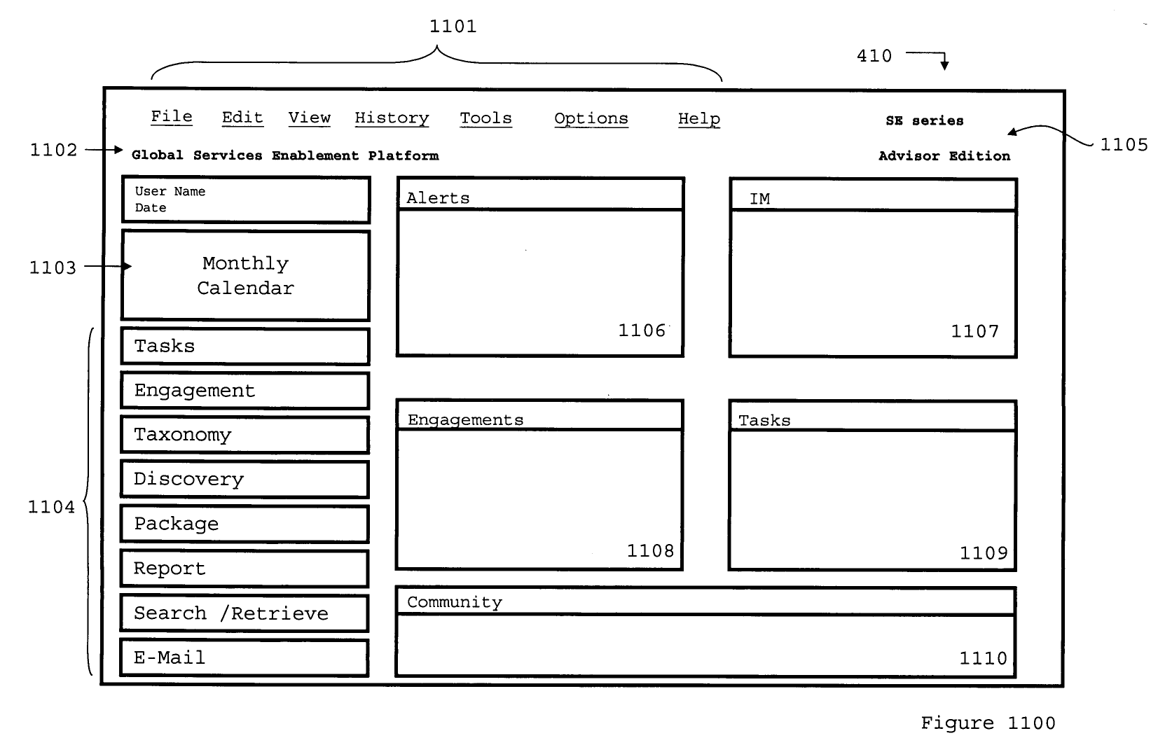

Another primary element in the system is the Screen item 410. This element embodies the graphical user interface utilized to interact with users of the system via one or combination of a range of embodiments of graphical elements including the use of ‘web browsers’ as is familiar to those knowledgeable in the art. Regardless, a primary purpose of the embodiment of the display, in conjunction with embodiments of other components of devices in FIG. 300 is to establish the human-to-machine interface. An illustration of an embodiment of such a display is depicted in FIG. 1100.

The look of the display is familiar to those knowledgeable in the art. The graphical icons item 1101 provides a means to ‘click’ with the mouse or equivalent component of the machine and invoke choices and follow through on choices. The graphical icons item 1104 offers the means to select one or more choices associated with invoking enablement-life-cycle related functionalities:
For instance, the graphical icon labeled Tasks invokes the functionality associated with one or more embodiments of the TASK object item 502 in FIG. 500.
The graphical icon labeled Engagement invokes the functionality associated with one or more embodiments of the ENGAGEMENT object item 504 in FIG. 500.
The graphical icon labeled Taxonomy provides the user the ability to invoke the functionality associated with one or more embodiments of the TAXONOMY object item 501 in FIG. 500 and follow through on establishing a ‘process family tree’ for the payroll-processing process as additionally described in FIG. 700.
The graphical icon labeled Discovery invokes the functionality associated with one or more embodiments of the DISCOVERY object item 505 in FIG. 500. The graphical icon labeled Package invokes the functionality associated with one or more embodiments of the PACKAGE object item 503 in FIG. 500.
The graphical icon labeled Report invokes the functionality associated with one or more embodiments of the REPORT object item 516 in FIG. 500.
The graphical icon labeled Search/Retrieve invokes the functionality associated with one or more embodiments of the STORE/RETRIEVE object item 507 in FIG. 500.
The graphical icon labeled E-Mail invokes the functionality associated with one or more embodiments of the functionality provided for E-MAIL functionality either within the system or external to it.

The graphical icon labeled Monthly Calendar item 1103 invokes the functionality of associated with an embodiment of one or more objects and functions in FIG. 450 to provide a monthly calendar for use during the course of using the system.

Item 1102 provides a commercial branding identity for the particular embodiment of the system as does item 1105. Various ‘windows’ as in item 1106, item 1107, item 1108, item 1109 and item 1110 display text, graphics, video and other forms of information and content in various embodiments. Some of this content is derived from the Enablement Data Repository item 445 and the others are from external systems and from other allied repositories.

Several embodiments and variations of FIG. 1100 are employed in the invention, associated with several preferred embodiments of the system as tailored to meet the needs of various categories of participants in the participant community. The embodiment of FIG. 1100 in an embodiment of the system tailored for the Enterprise utilizes a ‘look and feel’ and graphical icons suitable for a user in this participant category. The embodiment of FIG. 1100 in an embodiment of the system tailored for the Provider of outsourced services utilizes a ‘look and feel’ and graphical icons suitable for a preferred use by individuals in this participant category.

What is claimed is:

1. A system for integration of allied participant-systems and for achievement of ‘seamless enablement’ amongst participant-systems for inter and intra-enterprise autonomous compound processes for their enablement-life-cycle-stages, the system comprising:
at least one ubiquitous information system infrastructure to provide connectivity and access amongst disparate participant-systems;
at least one participant-system comprising a computer-device that participates via specified capacities in at least one enablement-life-cycle-stage;
at least one data repository containing data, content, computer instructions, and computer screen images pertaining to said enablement-life-cycle-stage;
at least one participant-system-to-user interface providing modes and orchestration for human user interaction with participant-systems;
at least one participant-system-to-participant-system interface providing modes and orchestration for participant-systems to interact with participant-systems;
means for articulation of enablement-life-cycle-stages;
at least one defined sequence of enablement-life-cycle-stages;
at least one scripted method for providing movement of instructions, information, data and content amongst participant-systems and connected devices;
at least one scripted method for providing individual enablement-life-cycle-stages;
at least one scripted method for providing defined sequences of enablement-life-cycle-stages;
means for generating scripted methods;
means for generating embodiments of participant-system-to-user interfaces and participant-system-to-participant-system interfaces;
at least one computer-readable memory comprising of computer-executable instructions to manifest the apparatuses; and
at least one mode of presentation of information and user-interaction selected from the group consisting of text, graphics, and multi-media.

2. The system of claim 1 further characterized by a scripted method for establishing participant-system communities involving at least one sub-community, the method comprising:
a. identifying at least one participating entity;
b. identifying at least one enterprise-process sub-process, or process-activity for enablement;
c. implementing at least one participant-system with the appropriate configuration of hardware, software and appropriate computer-executable instructions;
d. invoking within the participant-system at least one scripted method to articulate the enablement-life-cycle parameters; and
e. invoking at least one scripted method to guide the system to acquire and manage requisite seamless-enablement-life-cycle related identity information.

3. The system of claim 1 further characterized by a scripted method for establishing profiles for each enablement-life-cycle stage further comprising:
a. initiating interaction with at least one participant-system selected from the group consisting of the participant-system-to-user interface and the participant-system-to-participant-system interface;
b. utilizing the graphical icons to activate at least one apparatus associated with the script to guide the navigation of the steps associated with informing the participant-system of all the required data and content for the said enablement-life-cycle-stage;
c. confirming the user's concurrence with the profile so defined in the participant-system to the system via at least one graphical icon; and
d. repeating steps (a) through (c) until all enablement-life-cycle stages have been accommodated.

4. The system of claim 1 further characterized by a scripted method for progressing through at least one enablement-life-cycle-stage the method comprising:
a. utilizing the graphical icon to invoke at least one apparatus associated with the specific sequence of at least one enablement-life-cycle-stage; and
b. interacting with the participant-system to establish the data, content and contexts needed to facilitate the progression.

5. The system of claim 1 further characterized by a scripted method for establishing user-to-participant-system and participant-system-to-participant-system connectivity, the method comprising:
a. utilizing at least one graphical icon in the first participant-system to invoke at least one apparatus associated with establishing and authorizing access, use and exchange of data and content;
b. invoking at least one apparatus to authorize and establish connectivity at and for a second participant-system and to allow for access, use and exchange of data and content with the first participant-system; and
c. invoking at least one apparatus at each participant-system to actualize the connection.

6. The system of claim 1 further characterized by a method to achieve portability of information between authorized machines, the method comprising:
a. at least one additional method for establishment of communitywide standardized structures, language and vocabulary for arrangement, assembly, movement, storage and retrieval of data, content and information between all participant-systems and apparatuses in the participant-community;
b. utilizing at least one additional method to organize and reliably and securely transport and receive data, content, and information via a system selected from the group consisting of compact disks, computer memory storage devices, machine-to-machine File Transfer Protocols (FTP), TCP/IP protocols and shared data repositories; and
c. invoking at least one apparatus at each participating-system to execute the actions.

7. The system of claim 1 further characterized by a method for establishing at least one additional workflow object, the method comprising:
a. invoking at least one apparatus to execute the steps to articulate a new workflow method; and
b. invoking at least one additional apparatus to validate and accept the object and to integrate the logic within its workflow into at least one enablement-life-cycle-stages.

8. The system of claim 1 further characterized by a method to create collaborative sub-communities comprising participant-systems and sub-systems, the method comprising:
a. utilizing at least one additional method to establish collaboration parameters for purposes of forming a collaborative sub-community;
b. utilizing at least one additional method to establish profiles and authorizations for inclusion in the defined sub-community and to identify and validate common data, content, and information for use during the term of the collaboration; and
c. invoking apparatus to initiate and execute specific collaboration related actions.

9. The system of claim 1 further characterized by a method to create collaboration-groups involving a sub-community of participant-system-users, the method comprising:
a. utilizing at least one additional method to establish collaboration parameters for purposes of forming a collaborative sub-community;
b. utilizing at least one additional method to establish profiles and authorizations for inclusion in the defined sub-community and to identify and validate common data, content and information for use during the term of the collaboration; and
c. invoking at least one apparatus to initiate and execute specific collaboration related actions.

10. The system of claim 1 further characterized by a method to integrate a plurality of participant-systems in the compilation of data and content during a collaboration-session, the method comprising:
a. utilizing at least one additional method to identify and validate authorized collaborators for the session;
b. utilizing at least one additional method to establish profiles and authorizations for inclusion in the collaboration-session and to identify and validate common data, content and information for use during the collaboration-session; and
c. invoking at least one apparatus to initiate and execute specific collaboration related actions.

11. The system of claim 1 further characterized by an apparatus for establishing communities and sub-communities of logically integrated but physically disparate participant-systems, such apparatus comprising:
a. a configuration engine receiving a request from at least one workflow object for establishment of a community or sub-community;
b. a configuration engine querying a configuration profile maintained in at least one database and validating the identities of participant-systems;
c. the configuration engine requesting at least one database for enablement of topology data, topology traverse logic and security data and receiving the same;
d. the configuration engine creating a new organization of communities and sub-communities and forwarding details to at least one database regarding the same; and
e. the configuration engine forwarding a status-update to at least one workflow object indicating the fulfillment of the request.

12. The system of claim 1 further characterized by a computer-readable memory comprising computer-executable instructions that when executed cause:
a. a configuration engine to receive a request from at least one workflow object for establishment of a community;
b. a configuration engine to query a configuration profile maintained in at least one database to validate the identities of participant-systems;
c. the configuration engine to request at least one for enablement topology data, topology traverse logic and security data and to receive the same;
d. the configuration engine to create a new organization of community and to forward details to at least one database regarding the same; and
e. the configuration engine to forward a status-update to at least one workflow object indicating the fulfillment of the request.

13. The system of claim 1 further characterized by an apparatus for organizing the orchestration of the flow of interaction, logic, information, data and content inputs, outputs, display, storage, retrieval, analysis, distribution and processing within each participant system upon being instructed to do so such apparatus comprising:
a. a systems-management-engine receiving a request from at least one workflow object to respond to an initiating action;
b. the systems-management-engine responding to the request via an examination of a request-profile in at least one database;
c. the systems-management-engine thereafter invoking at least one method, object and apparatus to assemble task-packages to fulfill the request and delegating according to the functions performed by such methods, objects, and apparatuses;
d. the systems-management-engine monitoring the progress of achievement of all delegated tasks and reporting on the same to at least one workflow object responsible for oversight;
e. the systems-management-engine intervening with alternative instructions in the event at least one task is progressing as per script;
f. the systems-management-engine creating a response-profile indicating the status and outcome of the task actions and placing the task in at least one database; and
g. the configuration engine forwarding a status-update to at least one workflow object indicating the fulfillment of the request.

14. The system of claim 1 further characterized by computer-readable memory comprising computer-executable instructions that when executed cause:
a. a systems-management-engine to receive a request from at least one workflow object to respond to an initiating action;
b. the systems-management-engine to respond to the request via an examination of a request-profile placed in at least one database;
c. the systems-management-engine to then invoke at least one of a method, object, and apparatus to assemble task-packages to fulfill the request and to delegate these according to the functions performed by such methods, objects, and apparatuses;
d. the systems-management-engine to monitor the progress of achievement of all delegated tasks and to report on the same to at least one workflow object responsible for oversight;
e. the systems-management-engine to intervene with alternative instructions in the event at least one task is not progressing as per script;
f. the systems-management-engine to create a response-profile indicating the status and outcome of the task actions and to place the task in at least one database; and
g. the configuration engine to forward a status-update to at least one workflow object indicating the fulfillment of the request.

15. The system of claim 1 further characterized by an apparatus for executing at least one enablement-life-cycle stage, such apparatus comprising:
a. a life-cycle-management-engine receiving a request from at least one workflow object to respond to an initiating action regarding at least one enablement-life-cycle-stage;
b. the life-cycle-management-engine responding to the request via an examination of a request-profile placed for this purpose in at least one database;
c. the life-cycle-management-engine then invoking at least one object from its Core, Add-on and Custom objects to prepare the detailed list of tasks associated with the life-cycle-stage;
d. the life-cycle-management-engine then invoking at least one of a plurality of methods, objects and apparatuses to assemble task-packages to fulfill the request and delegating these according to the functions performed by such methods, objects, and apparatuses;
e. the life-cycle-management-engine monitoring the progress of achievement of all delegated tasks and reporting on the same to at least one workflow object responsible for oversight;
f. the life-cycle-management-engine intervening with alternative instructions in the event at least one task is not progressing as per script;
g. the life-cycle-management-engine creating a response-profile indicating the status and outcome of the task actions and placing it the task in at least one database, temporary and or permanent computer memory;
h. the life-cycle-management-engine repeating steps (b) through (g) in the event the request in step (a) pertains to a plurality of life-cycle-stages; and
i. the configuration engine forwarding a status-update to at least one workflow object indicating the fulfillment of the request.

16. The system of claim 1 further characterized by computer-readable memory comprising computer-executable instructions that when executed, cause:
a. a life-cycle-management-engine to receive a request from at least one workflow object to respond to an initiating action regarding at least on enablement-life-cycle-stage;
b. the life-cycle-management-engine for responding to the request via an examination of a request-profile placed for this purpose in at least one database;
c. the life-cycle-management-engine to then invoke at least one object from its Core, Add-on and Custom objects to prepare the detailed list of tasks associated with the life-cycle-stage;
d. the life-cycle-management-engine then invoking at least one of a plurality of methods, objects and apparatuses to assemble task-packages to fulfill the request and to delegate these according to the functions performed by such methods and apparatuses;
e. the life-cycle-management-engine for monitoring the progress of achievement of all delegated tasks and to report on the same to at least one workflow object responsible for oversight;
f. the life-cycle-management-engine intervening with alternative instructions in the event task is not progressing as per script;
g. the life-cycle-management-engine creating a response-profile indicating the status and outcome of the task actions and placing the task in at least one database;
h. the life-cycle-management-engine repeating steps (b) through (g) in the event the request in (a) pertains to a plurality of life-cycle-stages; and
i. the configuration engine forwarding status-update to at least one workflow object indicating the fulfillment of the request.

17. The system of claim 1 further characterized by an apparatus for maintaining updated states of data, information and content including past versions, current versions and intermediate versions, such apparatus comprising:
a. a state-management-engine receiving a request from at least one workflow object to respond to a an initiating action;
b. the state-management-engine responding to the request via an examination of a request-profile placed for this purpose in at least one database;
c. the state-management-engine then invoking at least one of a plurality of objects to prepare a detailed list of tasks associated with the lifecycle-stage;
d. the state-management-engine then invoking at least one of a plurality of methods such as ACTIVE, objects and apparatuses to assemble task-packages to fulfill the request and delegating these according to the functions performed by such methods and apparatuses;
e. the state-management-engine monitoring the progress of achievement of all delegated tasks and reporting on the same to at least one workflow object responsible for oversight;
f. the state-management-engine intervening with alternative instructions in the event that one of the plurality of tasks is not progressing as per script;
g. the state-management-engine creating a response-profile indicating the status and outcome of the task actions and placing the task in at least one database;
h. the state-management-engine repeating steps (b) through (g) in the event the request in (a) pertains to a plurality; and
i. the state-management-engine forwarding a status-update to at least one workflow object and management-engines indicating the fulfillment of the request.

18. The system of claim 1 further characterized by computer-readable memory comprising computer-executable instructions that when executed, cause:
a. a state-management-engine receiving a request from at least one workflow object to respond to an initiating action;
b. the state-management-engine responding to the request via an examination of a request-profile placed for this purpose in at least one database;
c. the state-management-engine thereafter invoking at least one of a plurality of objects to prepare the detailed list of tasks associated with the lifecycle-stage;
d. the state-management-engine thereafter invoking at least one method including ACTIVE, objects and apparatuses to assemble task-packages to fulfill the request and to delegate these according to the functions performed by such methods and apparatuses;
e. the state-management-engine monitoring the progress of achievement of all delegated tasks and to report on the same to at least one workflow objects responsible for oversight;
f. the state-management-engine intervening with alternative instructions in the event one task is not progressing as per script;
g. the state-management-engine creating a response-profile indicating the status and outcome of its actions and to place it in at least one of a plurality of databases, temporary and or permanent computer memory;
h. the state-management-engine repeating steps (b) through (g) in the event the request in (a) pertains to a plurality;
i. the state-management-engine forwarding a status-update to at least one workflow object and management-engine indicating the fulfillment of the request.

19. The system of claim 1 further characterized by an apparatus for establishing, sustaining and modifying a schema of identities related to every aspect of the system in claim 1 including community, participant, participant-system, workflow, process, permissions, information, content and data, such apparatus comprising:
a. a configuration engine receiving a request from at least one workflow object for establishment, sustenance or modification of at least one identity;
b. the configuration engine querying a identity profile maintained in at least one database and validating the identities of requesting workflow objects;
c. the configuration engine requesting at least one database for current status and states of such identities and receiving the same;
d. the configuration engine confirming the need to go-ahead with the requested new entry or change to current entry;
e. the configuration engine implementing the change and forwarding details to at least one database regarding the same;
f. the configuration engine repeating steps (b) through (e) until all requests are processed; and
g. the configuration engine forwarding a status-update to at least one workflow object indicating the fulfillment of the request

20. The system of claim 1 further characterized by computer-readable memory comprising computer-executable instructions that when executed, cause:
a. a configuration engine for receiving a request from at least one workflow object for establishment, sustenance, or modification of at least one identity for at least one aspect;
b. the configuration engine querying a identity profile maintained in at least one database and to validate the identities of requesting workflow objects;
c. the configuration engine requesting at least one database and for current status of such identities and to receive the same;
d. the configuration engine confirming the need to go-ahead with the requested new entry or change to current entry;
e. the configuration engine implementing the change and to forward details to at least one database regarding the same;
f. the configuration engine repeating steps (b) through (e) until all requests are processed; and
g. the configuration engine forwarding a status-update to at least one workflow object indicating the fulfillment of the request.

21. The system of claim 1 further characterized by an apparatus for establishing, sustaining and modifying a schema for end-to-end, seamless-enablement of all the life-cycle-stages in the community of participant-systems, such apparatus comprising:
a. a configuration engine receiving a request from at least one workflow object for establishment, sustenance or modification of at least one identity for at least one aspect of enablement such as topology, traverse map, security, collaboration groups, identity of databases and other repositories;
b. the configuration engine querying a identity profile maintained in at least one database and validating the identities of requesting workflow objects;
c. the configuration engine requesting at least one database for current status and states of such identities and receiving the same;
d. the configuration engine confirming the need to go-ahead with the requested new entry or a change to current entry;
e. the configuration engine implementing the change and forwarding details to at least one database regarding the same;
f. the configuration engine repeating steps (b) through (e) until all requests are processed;
g. the configuration engine forwarding a status-update to at least one workflow object indicating the fulfillment of the request.

22. The system of claim 1 further characterized by computer-readable memory comprising computer-executable instructions that when executed, cause:
a. a configuration engine for receiving a request from at least one workflow object for establishment, sustenance or modification of at least one identity for at least one aspect of enablement such as topology, traverse map, security, collaboration groups, identity of databases and other repositories;
b. the configuration engine querying a identity profile maintained in at least one database and to validate the identities of requesting workflow object;
c. the configuration engine requesting at least one database for current status and states of such identities and to receive the same;
d. the configuration engine confirming the need to go-ahead with the requested new entry or a change to current entry;
e. the configuration engine implementing the change and to forward details to at least one database regarding the same;
f. the configuration engine repeating steps (b) through (e) until all requests are processed; and
g. the configuration engine forwarding a status-update to at least one workflow object indicating the fulfillment of the request.
